(19) United States
(12) Patent Application Publication
(10) Pub. No.: US 2026/0099987 A1
(43) Pub. Date: Apr. 9, 2026

(54) 4D GENERATIVE MODELS FROM IN THE WILD VIDEOS

(71) Applicant: NVIDIA CORPORATION, Santa Clara, CA (US)

(72) Inventors: Koki NAGANO, Playa Vista, CA (US); Kaiwen JIANG, La Jolla, CA (US); Shalini DE MELLO, San Francisco, CA (US); Xueting LI, San Jose, CA (US)

(21) Appl. No.: 19/352,319

(22) Filed: Oct. 7, 2025

Related U.S. Application Data
(60) Provisional application No. 63/705,232, filed on Oct. 9, 2024.

(51) Int. Cl. G06T 15/08; G06N 3/08; H04N 21/81

(52) U.S. Cl. CPC G06T 15/08; G06N 3/08; H04N 21/816

(57) ABSTRACT

At least one embodiment for generating 4D generative models from in the wild videos includes receiving a first 2D image frame, processing the first 2D image frame to generate 3D Gaussians, defining a set of motion basis features from the 3D Gaussians, receiving a second 2D image frame, generating a plurality of augmented images based on the first 2D image frame and the second 2D image frame, processing the plurality of augmented images to generate a plurality of motion features, constructing deformed 3D Gaussians from the motion basis features and the motion features, generating a rendered 2D image from the deformed 3D Gaussians, and generating a 4D representation using a neural network trained based on the rendered 2D image and the second 2D image frame.

### CROSS-REFERENCE TO RELATED APPLICATIONS

This application claims priority benefit of the United States Provisional Patent Application titled, “GENERATING 4D GENERATIVE MODELS FROM IN THE WILD VIDEOS,” filed on Oct. 9, 2024, and having Ser. No. 63/705,232. The subject matter of this related application is hereby incorporated herein by reference.

### BACKGROUND OF THE INVENTION

### Field of the Invention

Embodiments of the present disclosure relate generally to virtual and augmented reality, four-dimensional mapping and environmental modeling, and artificial intelligence and, more specifically, to 4D generative models from in the wild videos.

### Description of the Related Art

Four-dimensional (4D) video generation is the task of generating a realistic 4D video from an input prompt. Input prompts can include a sparse set of two-dimensional (2D) images, in the wild video clips (i.e. video clips with no information about the intrinsic or extrinsic camera parameters), text, and/or audio. 4D video generation has numerous applications in a wide variety of fields, including computer graphics and animation.

Current techniques for 4D video generation are based on general adversarial network (GAN) approaches. A GAN is a type of artificial neural network model which simultaneously trains two neural network models, a generative network and a discriminative network, through an adversarial process. The generative network generates samples which are very similar to the input dataset and the discriminative network estimates the probability that a sample came from the input dataset rather than from the generative model. The GAN trains the generative network to maximize the probability that the discriminative network is being fooled by the generated samples and cannot tell whether a sample is from the input dataset or generated.

One drawback of using GANs for 4D video generation is that while GANs are capable of generating high-resolution, photorealistic 2D images which are nearly indistinguishable from real photographs, GANS struggle to generate realistic 4D videos. GANs are unable to accurately learn 3D dynamic geometry, resulting in objects that change appearance over the duration of the video. In addition, GANs have difficulty modeling human motion and expressions that change over time.

Another drawback of using GANs is that training a GAN is unstable. GANs are prone to mode collapse, where the generative network does not capture the diversity of the data distribution and produces a limited variety of samples. In addition, GANs are difficult to scale to a large-scale data set. As the complexity of the data increases, training a GAN becomes more unstable.

As the foregoing illustrates, what is needed in the art are more effective techniques for 4D video generation.

### SUMMARY

According to some embodiments, a computer-implemented method for generating a 4D representation. The method includes receiving a first two-dimensional (2D) image frame, processing the first 2D image frame to generate a plurality of 3D Gaussians, defining a set of motion basis features from the plurality of 3D Gaussians, receiving a second 2D image frame, generating a plurality of augmented images based on the first 2D image frame and the second 2D image frame, processing the plurality of augmented images to generate a plurality of motion features, constructing a plurality of deformed 3D Gaussians from the motion basis features and the motion features, generating a rendered 2D image from the plurality of deformed 3D Gaussians, and generating a 4D representation using a neural network trained based on the rendered 2D image and the second 2D image frame.

Further embodiments provide, among other things, non-transitory computer-readable storage media storing instructions and systems configured to implement the method set forth above.

At least one technical advantage of the disclosed techniques relative to the prior art is that, with the disclosed techniques, realistic 4D videos are generated from 2D image frames extracted from in the wild videos. The disclosed techniques generate 4D representations that more accurately model motion and expressions that change over time than prior art approaches. In addition, the disclosed techniques generate diverse 4D videos and are less prone to mode collapse, where a model generates limited or repetitive outputs. These technical improvements represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a block diagram of a computer-based system configured to implement one or more aspects of the various embodiments;

FIG. 5 is a more detailed description of the 4D representation generator of FIG. 4, according to various embodiments;

FIG. 6 is a more detailed description of the motion encoder of FIG. 5, according to various embodiments;

FIG. 7A is a more detailed description of training of the 4D video generation engine of FIG. 4, according to various embodiments;

FIG. 7B is a more detailed illustration of the 4D video generation engine of FIG. 4, according to various embodiments;

FIG. 8 is a flow diagram of method steps for generating 4D representations, according to various embodiments; and

FIG. 9 is a flow diagram of method steps for generating a 4D video, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

Embodiments of the present disclosure provide techniques for generating a 4D video from an audio input. First, a first 2D image frame is extracted from an in the wild video. Next, the first 2D image frame is transformed into a triplane representation by aligning the first 2D image frame along three orthogonal planes. 3D points are sampled along rays and projected onto each orthogonal plane to obtain feature vectors. The feature vectors are aggregated and input into a neural network. The output of the neural network is a set of 3D Gaussians. The parameters of the 3D Gaussians are used to define motion basis features. Next, a set of augmented images based on the first 2D image frame and a second 2D image frame from a different time step of the in the wild video is generated. The set of augmented images is input into a vision transformer, and the vision transformer outputs a set of motion features. The motion basis features and the motion features are used to construct a deformed set of 3D Gaussians. The deformed set of 3D Gaussians are rendered into a 2D image using a splatting-based rasterization technique. The neural network is then trained by minimizing the reconstruction loss between the rendered image and the second 2D image frame. Then, given an audio input, the 4D representations from the trained neural network are used by a diffusion model to generate 4D videos.

The techniques for generating 4D generative models from in the wild videos have many real world applications. For example, these techniques can be used in systems where 4D videos are generated using 2D images, such as virtual and augmented reality, and/or the like. These techniques also have applications in vehicle navigation systems, as well as medical imaging.

The above examples are not in any way intended to be limiting. As persons skilled in the art will appreciate, as a general matter, the techniques of generating 4D generative models from in the wild videos that are described herein can be implemented in any application where 4D video generation using 2D images is required or useful.

### System Overview

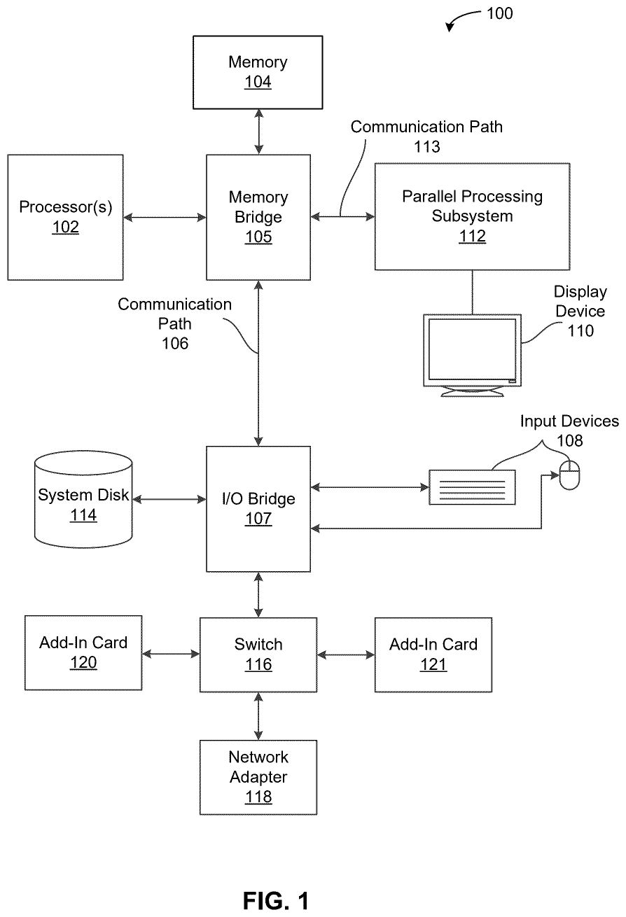

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, one or more processor(s) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to processor(s) 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 118. In one embodiment, switch 116 is configured to provide connections between I/O bridge 107 and other components of computer system 100, such as a network adapter 118 and various add-in cards 120 and 121.

In one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

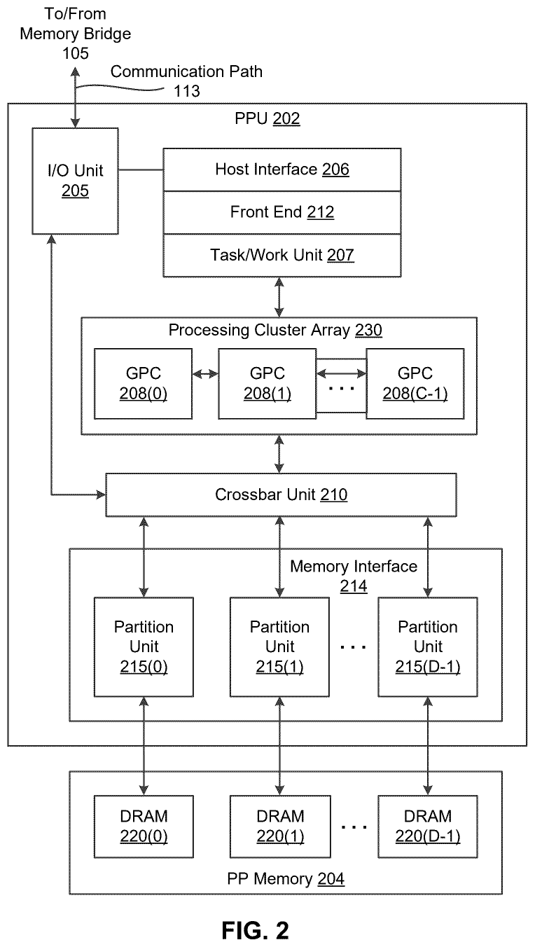

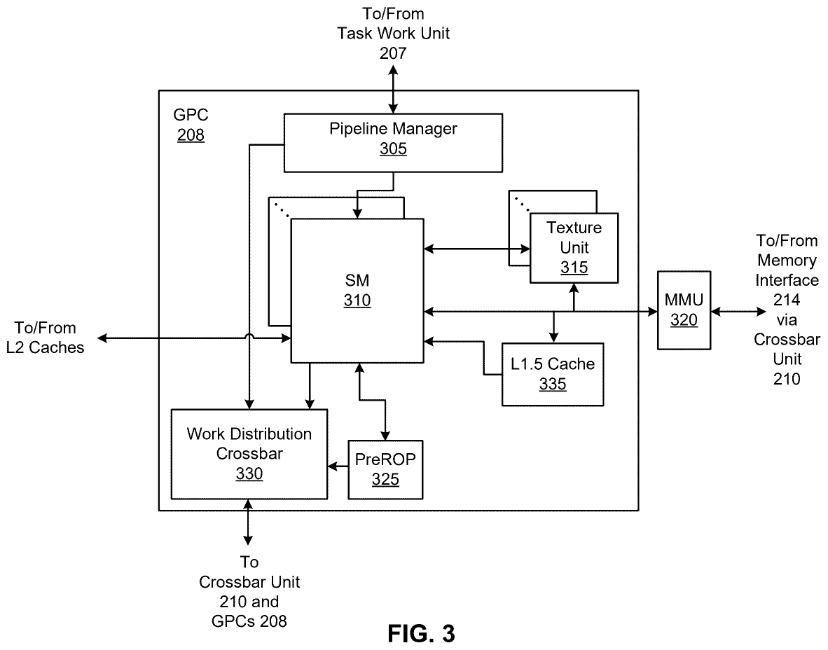

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on chip (SoC).

In one embodiment, processor(s) 102 include the master processor of computer system 100, controlling and coordinating operations of other system components. In one embodiment, processor(s) 102 issue commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in some embodiments, system memory 104 could be connected to processor(s) 102 directly rather than through memory bridge 105, and other devices would communicate with system memory 104 via memory bridge 105 and processor(s) 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 118 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by processor(s) 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 118.

In some embodiments, processor(s) 102 include the master processor of computer system 100, controlling and coordinating operations of other system components. In one embodiment, processor(s) 102 issue commands that control the operation of PPU 202. In some embodiments, processor(s) 102 write a stream of commands for PPU 202 to a data structure (not explicitly shown in either FIG. 1 or FIG. 2) that may be located in system memory 104, PP memory 204, or another storage location accessible to both processor(s) 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of processor(s) 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with processor(s) 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including processor(s) 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### 4D Representation Generation and Use

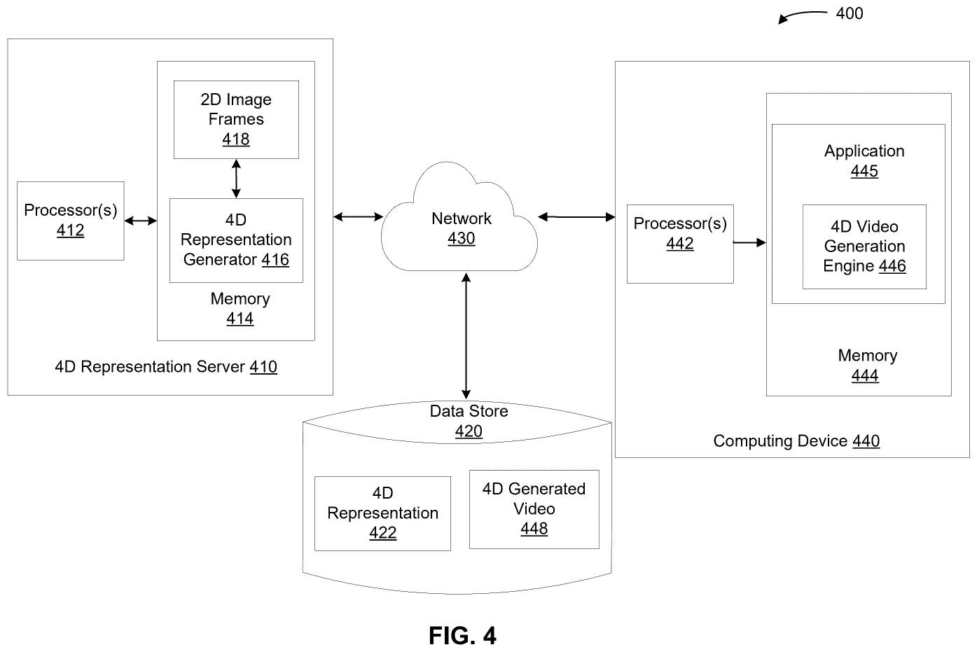

FIG. 4 illustrates a block diagram of a computer-based system 400 configured to implement one or more aspects of the various embodiments. As shown, computer-based system 400 includes, without limitation, a 4D representation server 410, a data store 420, a network 430, and a computing device 440. 4D representation server 410 includes, without limitation, processor(s) 412 and a memory 414. Memory 414 includes, without limitation, a 4D representation generator 416 and 2D image frames 418. Computing device 440 includes, without limitation, processor(s) 442 and memory 444. Memory 444 includes, without limitation, an application 445. Application 445 includes, without limitation, 4D video generation engine 446. Data store 420 stores, without limitation, 4D representation 422 and 4D generated video 448. Each of the 4D representation server 410 and the computing device 440 can include similar components, features, and/or functionality as the exemplary computer system 100, described above in conjunction with FIGS. 1-3. Each of 4D representation server 410 and computing device 440 can be any technically feasible type of computer system, including, without limitation, a server machine or a server platform.

4D representation server 410 shown herein is for illustrative purposes only, and variations and modifications are possible without departing from the scope of the present disclosure. For example, the number and types of processor(s) 412, the number of GPUs and/or other processing unit types, the number and types of memories 414, and/or the number of applications included in the memory 414 can be modified as desired. Further, the connection topology between the various units within 4D representation server 410 can be modified as desired. In some embodiments, any combination of the processor(s) 412 and the memory 414, and/or GPU(s) can be included in and/or replaced with any type of virtual computing system, distributed computing system, and/or cloud computing environment, such as a public, private, or a hybrid cloud system.

Processor(s) 412 receive user input from input devices, such as a keyboard or a mouse. Processor(s) 412 can be any technically feasible form of processing device configured to process data and execute program code. For example, any of processor(s) 412 could be a central processing unit (CPU), a graphics processing unit (GPU), an application-specific integrated circuit (ASIC), a field-programmable gate array (FPGA), and so forth. In various embodiments any of the operations and/or functions described herein can be performed by processor(s) 412, or any combination of these different processors, such as a CPU working in cooperation with one or more GPUs. In various embodiments, the processor(s) 412 can issue commands that control the operation of one or more GPUs (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of 4D representation server 410 stores content, such as software applications and data, for use by processor(s) 412. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor(s) 412. For example, and without limitation, the storage can include a Secure Digital Card, an external Flash memory, a portable compact disc read-only memory (CD-ROM), an optical storage device, a magnetic storage device, and/or any suitable combination of the foregoing.

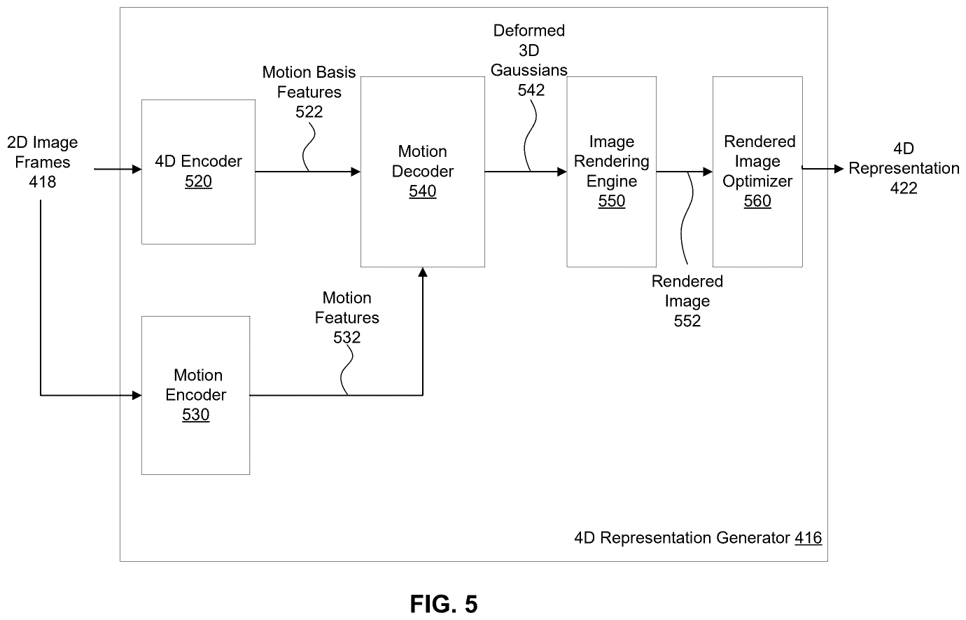

4D representation generator 416 stored within memory 414 is configured to generate 4D representation 422. First, a first 2D image frame 418 is extracted from an in the wild video and input into a neural network. The neural network outputs a set of 3D Gaussians. The set of 3D Gaussians are used to extract motion basis features. Next, the first 2D image frame 418 and a second 2D image frame 418 from a different time step of the in the wild video are input into a machine learning model and the machine learning model outputs a set of motion features. In some embodiments, the machine learning model is a vision transformer. The motion basis features and the motion features are used to construct a deformed set of 3D Gaussians. The deformed set of 3D Gaussians are rendered into a 2D image using a splatting-based rasterization technique. The encoder network is then trained by minimizing the reconstruction loss between the rendered image and the second 2D image frame 418. 4D representation generator 416 then stores 4D representation 422 in data store 420. 4D representation 422 can then be used in any suitable application, such as application 445 executing on computing device 440. The operations performed by 4D representation generator 416 to generate 4D representation 422 are described in greater detail below in conjunction with FIGS. 5, 6, 7A, and 7B.

2D image frames 418 are images obtained from different timesteps from an in the wild video. In the wild videos are videos with no information about the intrinsic or extrinsic camera parameters. 2D image frames 418 can be obtained by any type of technically feasible video capture device. For example, and without limitation, 2D image frames 418 can be obtained by a monocular camera such as a smartphone camera or a camera located in a vehicle. Although not shown in FIG. 4, 2D image frames images 418 can be loaded by 4D representation generator 416 from data store 420 and/or one or more other data repositories.

Data store 420 provides non-volatile storage for applications and data in 4D representation server 410 and computing device 440. For example, and without limitation, training data, trained (or deployed) machine learning models and/or application data, 2D image frames 418, 4D representation 422, and 4D generated video 448 can be stored in the data store 420 for use by application 445. In some embodiments, data store 420 can include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Data store 420 can be a network attached storage (NAS) and/or a storage area-network (SAN). Although shown as coupled to 4D representation server 410 and computing device 440 via network 430, in various embodiments, 4D representation server 410 or computing device 440 can include data store 420.

Network 430 includes any technically feasible type of communications network that allows data to be exchanged between 4D representation server 410, computing device 440, data store 420 and external entities or devices, such as a web server or another networked computing device. For example, network 430 can include a wide area network (WAN), a local area network (LAN), a cellular network, a wireless (WiFi) network, and/or the Internet, among others.

Computing device 440 shown herein is for illustrative purposes only, and variations and modifications are possible without departing from the scope of the present disclosure. For example, the number and types of processor(s) 442, the number and types of memories 444, and/or the number of applications included in the memory 444 can be modified as desired. Further, the connection topology between the various units within computing device 440 can be modified as desired. In some embodiments, any combination of the processor(s) 442 and/or the memory 444 can be included in and/or replaced with any type of virtual computing system, distributed computing system, and/or cloud computing environment, such as a public, private, or a hybrid cloud system. In various embodiments, computing device 440 can be implemented using any of the computing devices of FIGS. 1-3.

Similar to processor(s) 412, processor(s) 442 receive user input from input devices, such as a keyboard or a mouse. Processor(s) 442 can be any technically feasible form of processing device configured to process data and execute program code. For example, any of processor(s) 442 could be a CPU, a GPU, an ASIC, a FPGA, and so forth. In various embodiments any of the operations and/or functions described herein can be performed by processor(s) 442, or any combination of these different processors, such as a CPU working in cooperation with a one or more GPUs. In various embodiments, the one or more GPU(s) perform parallel processing task, such as matrix multiplications and/or the like in LLM model computations. Processor(s) 442 can also receive user input from input devices, such as a keyboard or a mouse and generate output on one or more displays.

Similar to memory 414 of 4D representation server 410, memory 444 of computing device 440 stores content, such as software applications and data, for use by the processor(s) 442. The memory 444 can be any type of memory capable of storing data and software applications, such as a RAM, ROM, EPROM, Flash ROM, or any suitable combination of the foregoing. In some embodiments, a storage (not shown) can supplement or replace the memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

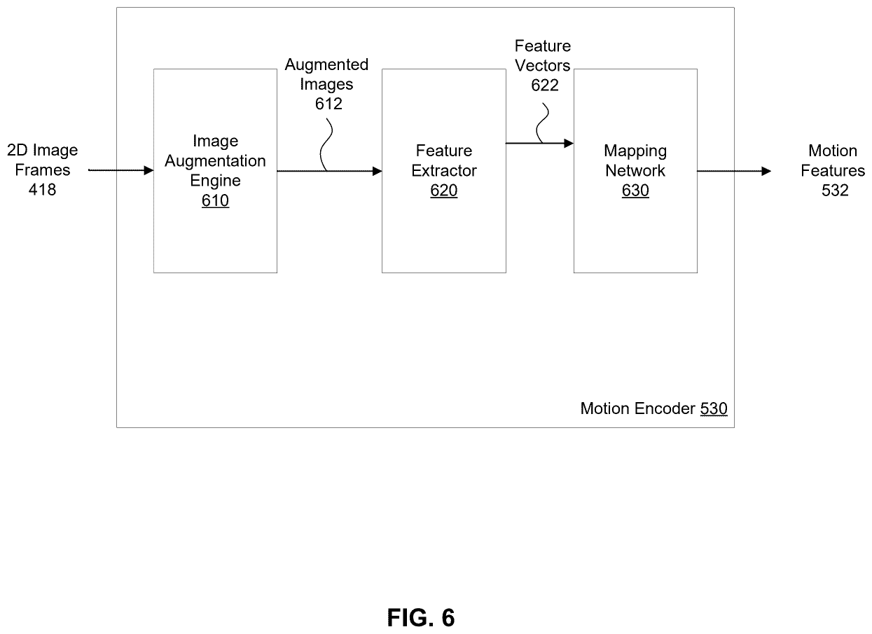

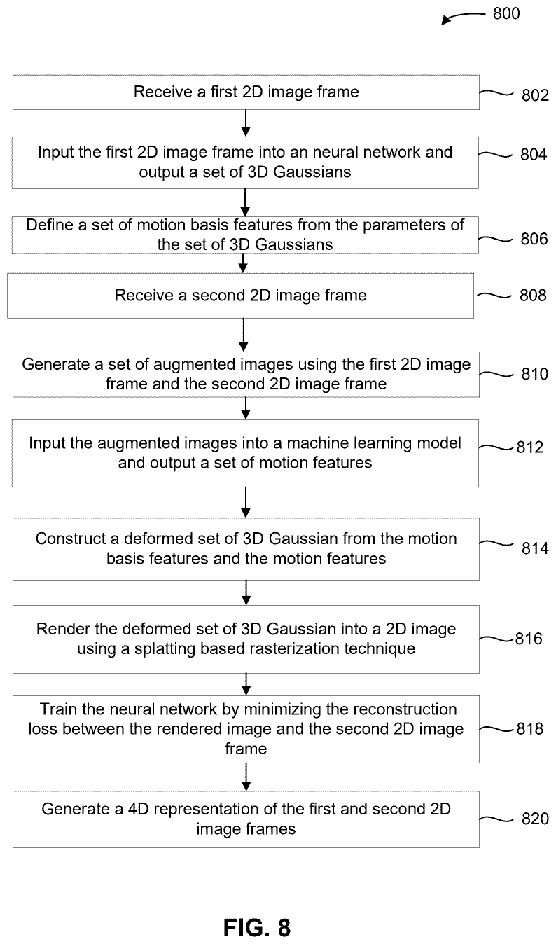

As shown, memory 444 includes application 445. Application 445 includes 4D video generation engine 446. 4D video generation engine 446 is configured to generate 4D generated video 448 using 4D representation 422. Given an image or audio input prompt, 4D video generation engine 446 uses 4D representation 422 to train a diffusion model to generate 4D generated video 448. 4D video generation engine 446 then stores 4D generated video 448 in data store 420. 4D generated video 448 can then be used in any suitable application, such as application 445 executing on computing device 440. The operations performed by 4D video generation engine 446 to generate 4D generated video 448 are described in greater detail below in conjunction with FIGS. 6 and 8.

Application 445 can be, without limitation, any type of video game or computer animation generation system, navigation system, map, or route and direction assistant in an autonomous or manned vehicle and/or a hand-held device. For example, application 445 can receive audio or input prompts and use 4D video generation engine 446 to generate 4D generated video 448 that closely matches the original input prompt. In various embodiments, application 445 can load 4D generated video 448 and then use vehicle location and position information and 4D generated video 448 to show previews of a planned route, render a view from specific coordinates, or annotate an image to displays landmarks or other points of interest.

FIG. 5 is a more detailed illustration of 4D representation generator 416 of FIG. 4, according to various embodiments. As shown, 4D representation generator 416 includes, without limitation, a 4D encoder 520, a motion encoder 530, a motion decoder 540, an image rendering engine 550, and a rendered image optimizer 560. 4D encoder 520 receives 2D image frames 418 and generates motion basis features 522. Motion encoder 530 receives 2D image frames 418 and generates motion features 532. Motion decoder 540 receives motion basis features 522 and motion features 532 and generates deformed 3D Gaussians 542. Image rendering engine receives deformed 3D Gaussians 542 and generates rendered image 552. Rendered image optimizer receives rendered image 552 and generates 4D representation 422. 4D representation generator 416 receives 2D image frames 418 and generates 4D representation 422.

4D encoder 520 receives a first 2D image frame from 2D image frames 418. First, 4D encoder 520 transforms the first 2D image frame 418 into a triplane 3D representation. In a triplane 3D representation, the features of 2D image frame 418 are aligned along three orthogonal 2D feature planes each with resolution of N×N×C, where N is the spatial resolution and C is the number of channels, aligned with the xy, xz and yz planes. 4D encoder 520 then samples a set of 3D points along rays. Each ray is given according to equation (1):

$$r ( t ) = o + td \qquad ( 1 )$$

where o is the origin of the ray and d is the direction of ray. Then, for each sampled 3D point, x=(x, y, z), 4D encoder 520 projects x onto each of the three 2D feature planes and uses bilinear interpolation to obtain the feature vectors f_{xy}, f_{xz}, and f_{yz}, where fᵢⱼ is the feature vector obtained by projecting x onto the ij plane and bilinearly interpolating the nearby features. 4D encoder 520 then aggregates the three feature vectors by summation and passes the aggregated features through a neural network. In various embodiments, the neural network has a varying number of internal parameters including, without limitation, number of layers, types of layers, numbers of neurons, types of activation function, and/or the like. The output of the neural network is a set of 3D Gaussians. Each 3D Gaussian is defined in terms of the center μ, rotation q, scaling vector s, and opacity α. The parameters [μ, q, s, α] of each 3D Gaussian form a set of motion basis features 522. For each 3D Gaussian, a motion basis feature 522, v, is defined, where the parameters of the 3D Gaussian are the components of the motion basis feature 522, v=[μ, q, s, α].

Motion encoder 530 receives the first 2D image frame and a second 2D image frame from a different timestep of 2D image frames 418. Motion encoder 530 generates motion features 532. The operations of motion encoder 530 are described in further detail below in conjunction with FIG. 6.

FIG. 6 is a more detailed illustration of motion encoder 530 of FIG. 5, according to various embodiments. As shown, motion encoder 530 includes, without limitation, image augmentation engine 610, feature extractor 620, and mapping network 630. Image augmentation engine 610 receives 2D image frames 418 and generates augmented images 612. Feature extractor 620 receives augmented images 612 and generates feature vectors 622. As noted above, motion encoder receives 2D image frames 418 and generates motion features 532.

Image augmentation engine 610 receives the first 2D image frame and the second 2D image frame of 2D image frames 418. Image augmentation engine 610 disturbs the pose information of the first 2D image frame and the second 2D image frame of 2D image frames 418 to generate a set of augmented images 612. In various embodiments, augmented images 612 are images that look very similar to the first 2D image frame and the second 2D image frame of 2D image frames 418. For example, and without limitation, augmented image 612 can be a rotated, cropped, or blurred version of the first 2D image frame or the second 2D image frame of 2D image frames 418. Image augmentation engine 610 then passes augmented images 612 to feature extractor 620.

Feature extractor 620 receives augmented images 612. Feature extractor 620 can be any type of technically feasible machine learning model. For example, in various embodiments, feature extractor 620 can be a vision transformer with any suitable architecture. More generally, the input dataset to feature extractor 620 can include any technically feasible data that can be processed by a transformer-based model for computer vision. For each input image, feature extractor 620 generate a feature vector 622. A feature vector 622 includes information on the features across a given image. In various embodiments, features include distinct structures within an image, such as edges and parts of objects within the given image. Feature extractor 620 then passes feature vectors 622 to mapping network 630.

Mapping network 630 receives feature vectors 622 from feature extractor 620. Mapping network 630 can be any type of technically feasible machine learning model. In various embodiments, mapping network 630 can be a transformer-based machine learning model with any suitable architecture. Upon receiving feature vectors 622, mapping network 630 passes feature vectors through multiple layers. Each layer of mapping network 630 can include an attention layer, fully connected layer, a normalization layer, and/or any other type of viable artificial neural network layer. Each layer of mapping network 630 has a varying number of internal parameters including, without limitation, numbers of neurons, types of activation function, and/or the like. Passing each of feature vectors 622 through the layers of mapping network 630 removes the pose and identity information from each feature vector 622 and generates a corresponding motion feature 532. Mapping network 630 then passes motion features 532 to motion decoder 540.

Referring back to FIG. 5, motion decoder 540 receives motion basis features 522 from 4D encoder 520 and motion features 532 from motion encoder 530. Motion decoder 540 can be any type of technically feasible transformer-based machine learning model with any suitable architecture. In various embodiments, motion decoder 540 includes multiple transformer blocks. Each transformer block of motion decoder 540 can include multiple layers, including an attention layer, a multilayer perceptron (MLP) layer, and/or the like. Each transformer block has varying numbers of internal parameters including, without limitation, numbers of attention heads, key-value projection dimensions, numbers of neurons, types of activation functions, and/or the like. In various embodiments, motion decoder 540 uses cross-attention to establish the relationship between motion basis features 522 and motion features 532. Motion decoder 540 outputs a predicted motion basis that estimates in what direction the features of the first image frame have moved. The position and deformation information in the predicted motion basis is used to construct a set of deformed 3D Gaussians 542. Like the 3D Gaussians from 4D encoder 520, the deformed 3D Gaussians 542 are defined in terms of the center u, rotation q, scaling vector s, and opacity a. The deformed 3D Gaussians 542 are translations of the 3D Gaussians from 4D encoder 520.

Image rendering engine 550 receives deformed 3D Gaussians 542. Image rendering engine 550 then uses a splatting-based rasterization technique to generate rendered image 552. More specifically, image rendering engine 550 projects the deformed 3D Gaussians 542 onto a 2D pixel-based image plane. The deformed 3D Gaussians 542 are then sorted and a color of a pixel, C, is computed by blending [symbol] ordered points overlapping the pixel according to equation (2):

$$C = {\sum }_{i ∈ 𝒩} {c}_{i} {α}_{i} {\prod }_{j = 1}^{i - 1} ( 1 - {α}_{j} ) \qquad ( 2 )$$

where c; is the color of each point and a; is the opacity, resulting in rendered image 552. Rendered image 552 is then passed to rendered image optimizer 560.

Rendered image optimizer 560 receives rendered image 552 from image rendering engine 550. Rendered image optimizer trains rendered image 552 to closely match the second 2D image frame 418. Rendered image optimizer 560 can use any feasible training technique to train rendered image 552, such as stochastic gradient descent. During training, rendered image optimizer 560 minimizes the rendering loss between rendered image 552 and the second 2D image frame 418. The rendering loss function can include, without limitation, one or more of mean squared error (MSE), L1 loss, and/or the like. Rendered image optimizer 560 then updates the parameters [μ, q, s, α, c] of the deformed 3D Gaussians 542. Rendered image optimizer 560 then generates 4D representation 422 from the spatial and temporal information of the deformed 3D Gaussians 542.

### 4D Video Generation and Use

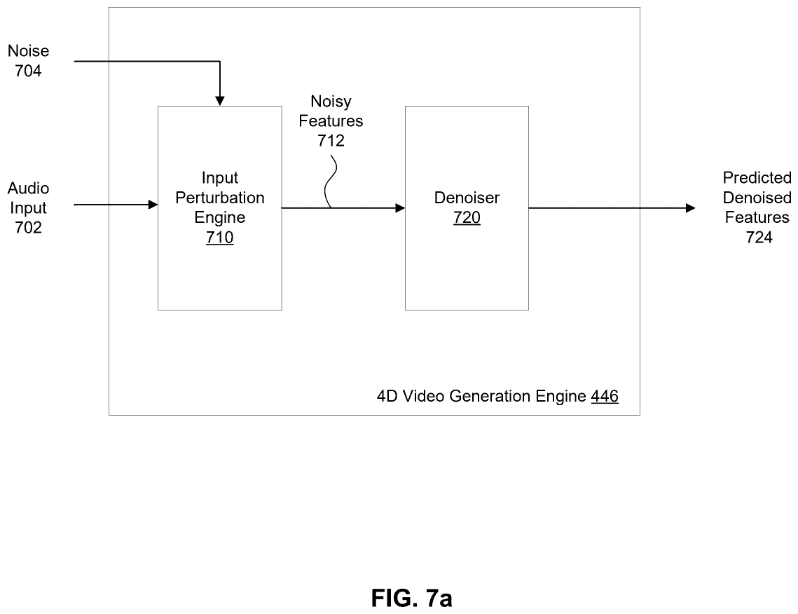

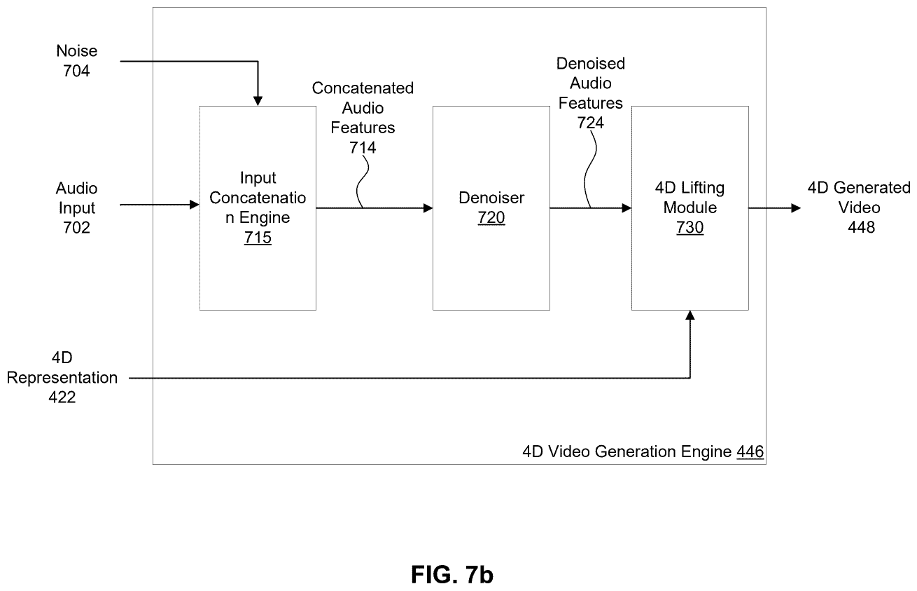

FIG. 7A is a more detailed illustration of training 4D video generation engine 446 of FIG. 4, according to various embodiments. As shown, 4D video generation engine 446 includes, without limitation, an input perturbation engine 710, and a denoiser 720. Input perturbation engine 710 receives audio input 702, noise 704 and generates noisy features 712. Denoiser 720 receives noisy features 712 and generates predicted denoised features 722. 4D video generation engine 446 is a diffusion model that receives audio input 702, noise 704, 4D representation 422, and generates 4D generated video 448. Diffusion models are probabilistic generative models that are trained by gradually destroying data by injecting noise, then gradually removing the noise. After training, diffusion models are able to generate new samples with a similar distribution as the training data set.

In various embodiments, and without limitation, audio input 702 can be an audio signal captured from a microphone. In various embodiments, audio input 702 is music, speech, or environmental sound. For example and without limitation, audio input 702 can be a waveform audio file. Waveform is an audio file format that contains uncompressed, raw audio data. In various embodiments, audio input 702 is stored in data store 420.

Noise 704 is any random or unwanted signal. In various embodiments, noise 704 is a signal noise classified according to statistical properties. For example and without limitation, noise 704 can be Gaussian noise, a signal noise with normally distributed probability density function, and/or other type of noise.

Input perturbation engine 710 receives audio input 702 and noise 704. Input perturbation engine 710 iteratively perturbs the audio input 702 by gradually adding noise 704 to generate noisy audio features 712. More specifically, given an audio feature of audio input 702, x₀, sampled from probability distribution q(x), input perturbation engine 710 generates a sequence x₁, x₂, . . . , x_{T}, where at each step t noise 704 with variance βₜ is added to xₜ₋₁ to generate xₜ. After T iterations, input perturbation engine 710 generates noisy features 712, x_{T}. Noisy features 712 are then passed to denoiser 720.

Denoiser 720 receives noisy features 712 from input perturbation engine 710. Denoiser 720 iteratively removes the noise from noisy features 712 to generate predicted denoised feature 722. For a noisy feature 712, denoiser 720 tries to recover the original audio features by generating a sequence in the reverse time direction, gradually removing the noise at each step. Denoiser 720 can be any type of technically feasible machine learning model. In various embodiments, denoiser 720 is a transformer-based machine learning model with any suitable architecture. In various embodiments, denoiser 720 is trained by diffusion forcing. Diffusion forcing is a training algorithm for causal sequence neural networks, such as recurrent neural networks or transformers, to denoise flexible-length sequences where each frame of the sequence can have a different noise level.

FIG. 7B is a more detailed illustration of 4D video generation engine 446 of FIG. 4, according to various embodiments. As shown, 4D video generation engine 446 includes, without limitation, input concatenation engine 715, denoiser 720, and 4D lifting module 730. Input concatenation engine 715 receives noise 704 and audio input 702 and generates concatenated audio features 714. Denoiser 720 receives concatenated audio features 714 and generates denoised audio features 724. 4D lifting module 730 receives denoised audio features 724 and 4D representation 422 and generates 4D generated video 448.

Input concatenation engine 715 receives noise 704 and audio input 702. Input concatenation engine concatenates audio input 702 and noise 704 to generate concatenated audio features 714.

Denoiser 720 receives concatenated audio features 714. Denoiser 720 iteratively removes noise 704 from concatenated audio features 714 by generating a sequence in the reverse time direction, gradually removing noise at each step to generate denoised audio features 724. Then, denoiser 720 passes denoised audio features 724 to 4D lifting module 730.

4D lifting module 730 receives denoised audio features 724 and accesses 4D representation 422 from data store 420. 4D lifting module matches the relevant motion information in denoised audio features 724 with 4D representation 422. Then, 4D lifting module 730 generates 4D generated video using denoised audio feature 724 synchronized to 4D representation 422.

### Generating 4D Representation

FIG. 8 is a flow diagram of method steps for generating a 4D representation according to various embodiments. Although the method steps are described in conjunction with the systems of FIG. 1-7, persons skilled in the art will understand that any system configured to perform the method steps, in any order, falls within the scope of the various embodiments.

As shown, a method 800 begins at step 802, where 4D representation generator 416 receives a first 2D image frame 418. 2D image frames 418 are images obtained from different timesteps from an in the wild video. In the wild videos are videos with no information about the intrinsic or extrinsic camera parameters. 2D image frames 418 can be obtained by any type of technically feasible video capture device.

At step 804, 4D encoder 520 inputs the first 2D image frame to an encoder network and outputs a set of 3D Gaussians. First, 4D encoder 520 transforms the first 2D image frame 418 into a triplane 3D representation. 4D encoder 520 then samples a set of 3D points along rays and for each sampled 3D point, 4D encoder 520 projects that 3D point onto each of the three 2D feature planes and uses bilinear interpolation to obtain three feature vectors. 4D encoder 520 then aggregates the three feature vectors by summation and passes the aggregated features through a neural network. The output of the neural network is a set of 3D Gaussians.

At step 806, 4D encoder 520 defines a set of motion basis features from the parameters of the set of 3D Gaussians. Each 3D Gaussian is defined in terms of the center μ, rotation q, scaling vector s, and opacity α. For each 3D Gaussian, a motion basis feature 522, v, is defined, where the parameters of the 3D Gaussian are the components of the motion basis feature 522, v=[μ, q, s, α].

At step 808, motion encoder 530 receives a second 2D image frame. The second 2D image frame is a 2D image from a different timestep then the first 2D image frame of 2D image frames 418.

At step 810, image augmentation engine 610 generates a set of augmented images 612 based on the first 2D image frame, the second 2D image frame. More specifically, image augmentation engine 610 disturbs the pose information of the first 2D image frame and the second 2D image frame of 2D image frames 418 to generate a set of augmented images 612. In various embodiments, augmented images 612 are images that look very similar to the first 2D image frame and the second 2D image frame of 2D image frames 418. For example, and without limitation, augmented image 612 can be a rotated, cropped, or blurred version of the first 2D image frame or the second 2D image frame of 2D image frames 418.

At step 812, the augmented images 612 are input into a machine learning model to obtain a set of motion features 532. More specifically, feature extractor 620 receives augmented images 612 and for each augmented image 612, feature extractor 620 generates a feature vector 622. Feature extractor 620 then passes feature vectors 622 to mapping network 630. Upon receiving feature vectors 622, mapping network 630 passes feature vectors through multiple layers. Passing each of feature vectors 622 through the layers of mapping network 630 removes the pose and identity information from each feature vector 622 and generates a corresponding motion feature 532.

At step 814, mapping network 630 constructs a deformed set of 3D Gaussians 542 from the motion basis features 522 and motion features 532. More specifically, motion decoder 540 receives motion basis features 522 from 4D encoder 520 and motion features 532 from motion encoder 530 and outputs a predicted motion basis. The predicted motion basis is a vector v′=[μ+Δμ,q+Δq,s+Δs,α+Δα] that estimates in what direction the motion basis features 522 of the first 2D image frame have moved according to the motion features 532. The components of the predicted motion basis are used to construct a set of deformed 3D Gaussians 542. Like the 3D Gaussians from 4D encoder 520, the deformed 3D Gaussians 542 are defined in terms of the center μ′, rotation q′, scaling vector s′, and opacity α′. The deformed 3D Gaussians 542 are translations of the 3D Gaussians from 4D encoder 520.

At step 816, image rendering engine 550 renders the deformed 3D Gaussians 542 into a 2D image using a splatting-based rasterization technique. First, image rendering engine 550 projects the deformed 3D Gaussians 542 onto a 2D pixel-based image plane. Image rendering engine 550 then uses equation (2) to compute the color of each pixel of the 2D image plane, resulting in rendered image 552.

At step 818, rendered image optimizer 560 trains the encoder network by minimizing the reconstruction loss between the rendered image 552 and the first 2D image frame 418. More specifically, rendered image optimizer trains rendered image 552 to closely match the second 2D image frame 418. Rendered image optimizer 560 can use any feasible training technique to train rendered image 552, such as stochastic gradient descent. During training, rendered image optimizer 560 minimizes the rendering loss between rendered image 552 and the second 2D image frame 418. The rendering loss function can include, without limitation, one or more of mean squared error (MSE), L₁ loss, and/or the like. Rendered image optimizer 560 then updates the parameters [μ, q, s, α, c] of the deformed 3D Gaussians 542.

At step 820, rendered image optimizer 560 generates a 4D representation of the first and second 2D image frames. More specifically, rendered image optimizer 560 generates 4D representation 422 by splatting the deformed 3D Gaussians 542.

### Generating 4D Generated Video

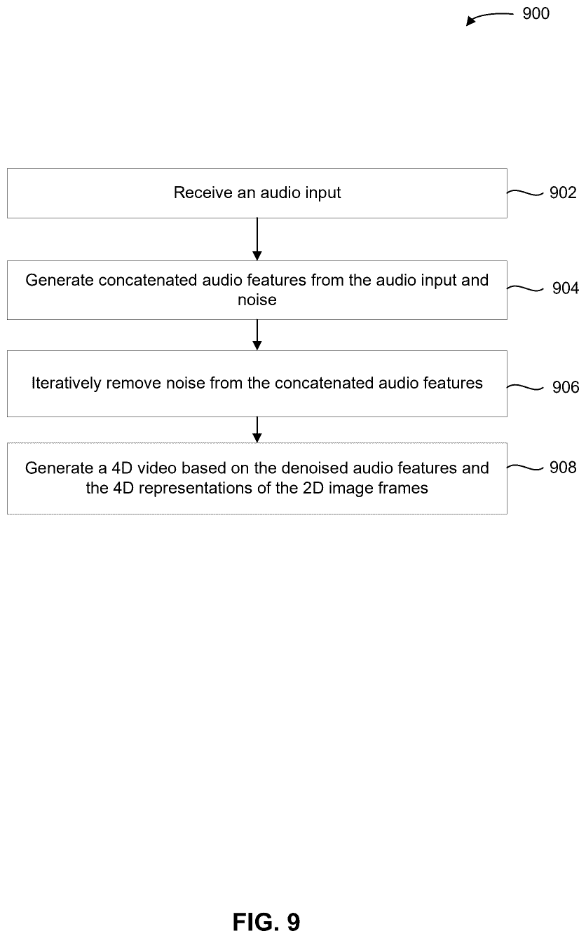

FIG. 9 is a flow diagram of method steps for generating 4D reconstructed video, according to various embodiments. Although the method steps are described in conjunction with the systems of FIGS. 1-7, persons skilled in the art will understand that any system configured to perform the method steps, in any order, falls within the scope of the various embodiments.

As shown, a method 900 begins at step 902, where input perturbation engine 710 receives audio input 702. In various embodiments, and without limitation, audio input 702 can be an audio signal captured from a microphone. In various embodiments, audio input 702 is music, speech, or environmental sound.

At step 904, input concatenation engine 715 generates concatenated audio features 724 from audio input 702 and noise 704. More specifically, input concatenation engine 715 generates concatenated audio features 724 by concatenating audio input 702 and noise 704.

At step 906, denoiser 720 iteratively removes noise from the concatenated audio features 714. Denoiser 720 iteratively removes the noise from concatenated audio features 714 to generate denoised audio feature 724. For a concatenated audio feature 714, denoiser 720 tries to recover the original audio features by generating a sequence in the reverse time direction, gradually removing the noise at each step. In various embodiments, denoiser 720 is a transformer-based machine learning model trained by diffusion forcing.

At step 908, 4D lifting module 730 generates a 4D video based on the denoised audio features 724 and the 4D representation 422 of the 2D image frames 418. More specifically, 4D lifting module matches the relevant motion information in denoised audio features 724 with the corresponding motion information in 4D representation 422 to generate 4D generated video 448.

In sum, a 4D video is generated from an in the wild video. First, a first 2D image frame is extracted from an in the wild video. Next, the first 2D image frame is transformed into a triplane representation by aligning first 2D image frame along three orthogonal planes. 3D points are sampled along rays and projected onto each orthogonal plane to obtain feature vectors. The feature vectors are aggregated and input into a neural network. The output of the neural network is a set of 3D Gaussians. The parameters of the 3D Gaussians are used to define motion basis features. Next, a set of augmented images based on the first 2D image frame and a second 2D image frame from a different time step of the in the wild video is generated and the set of augmented images is input into a vision transformer and the vision transformer outputs a set of motion features. The motion basis features and motion features are used to construct a deformed set of 3D Gaussian. The deformed set of 3D Gaussian are rendered into a 2D image using a splatting-based rasterization technique. The neural network is then trained by minimizing the reconstruction loss between the rendered image and the second 2D image frame. Then, given an audio input, the 4D representations from the trained neural network are used by a diffusion model to generate 4D videos.

At least one technical advantage of the disclosed techniques relative to the prior art is that, with the disclosed techniques, realistic 4D videos are generated from 2D image frames extracted from in the wild videos. The disclosed techniques generate 4D representations that more accurately model motion and expressions that change over time than prior art approaches. In addition, the disclosed techniques generate diverse 4D videos and are less prone to mode collapse, where a model generates limited or repetitive outputs. These technical improvements represent one or more technological improvements over prior art approaches.

Aspects of the subject matter described herein are set out in the following numbered clauses.
1. In some embodiments, a computer-implemented method for generating four-dimensional (4D) representation comprises receiving a first two-dimensional (2D) image frame, processing the first 2D image frame to generate a plurality of 3D Gaussians, defining a set of motion basis features from the plurality of 3D Gaussians, receiving a second 2D image frame, generating a plurality of augmented images based on the first 2D image frame and the second 2D image frame, processing the first 2D image frame, the second 2D image frame, and the plurality of augmented images to generate a plurality of motion features, constructing a plurality of deformed 3D Gaussians from the motion basis features and the motion features, generating a rendered 2D image from the plurality of deformed 3D Gaussians, and generating a 4D representation using a trained neural network.
2. The computer-implemented method of clause 1, further comprising transforming the first 2D image frame into a 3D representation by aligning features of the first 2D image frame along a plurality of orthogonal planes.
3. The computer-implemented method of clauses 1 or 2, further comprising generating a plurality of feature vectors by sampling a plurality of 3D points along rays and projecting each of the plurality of 3D points onto the plurality of orthogonal planes.
4. The computer-implemented method of any of clauses 1-3, wherein constructing the plurality of deformed 3D Gaussians comprises translating the plurality of 3D Gaussians based on the plurality of motion features.
5. The computer-implemented method of any of clauses 1-4, wherein the trained neural network is trained by minimizing rendering loss between the rendered 2D image and the second 2D image frame.
6. The computer-implemented method of any of clauses 1-5, wherein generating the motion features comprises processing the first 2D image frame, the second 2D image frame, and the plurality of augmented images using a vision transformer.
7. The computer-implemented method of any of clauses 1-6, wherein generating the rendered 2D image comprises performing splatting using the plurality of deformed 3D Gaussians.
8. The computer-implemented method of any of clauses 1-7, further comprising generating a 4D video using the 4D representation.
9. The computer-implemented method of any of clauses 1-8, wherein generating the 4D video comprises receiving an audio input, concatenating the audio input and noise removing noise from the concatenated audio input and noise to generate denoised audio features, and generating the 4D video based on the denoised audio features and the 4D representation.
10. The computer-implemented method of any of clauses 1-9, wherein generating the 4D video comprises processing the 4D representation with a diffusion model.
11. The computer-implemented method of any of clauses 1-10, wherein the diffusion model is trained by receiving an audio input, generating noisy features by generating a sequence where, at each step, noise is added to the audio input, and generating predicted denoised features by generating a sequence, where, at each step noise is iteratively removed.
12. The computer-implemented method of any of clauses 1-11, wherein the diffusion model is trained by diffusion forcing.
13. The computer-implemented method of any of clauses 1-12, wherein the noise comprises Gaussian noise.
14. In some embodiments, one or more non-transitory computer-readable media store instructions that, when executed by at least one processor, cause the at least one processor to perform the steps of receiving a first 2D image frame, processing the first 2D image frame to generate a plurality of 3D Gaussians, defining a set of motion basis features from the plurality of 3D Gaussians, receiving a second 2D image frame, generating a plurality of augmented images based on the first 2D image frame and the second 2D image frame, processing the first 2D image frame, the second 2D image frame, and the plurality of augmented images to generate a plurality of motion features, constructing a plurality of deformed 3D Gaussians from the motion basis features and the motion features, generating a rendered 2D image from the plurality of deformed 3D Gaussians, generating a 4D representation using a trained neural network.
15. The one or more non-transitory computer-readable media of clause 14, wherein the steps further comprise transforming the first 2D image frame into a 3D representation by aligning the features of the first 2D image frame along a plurality of orthogonal planes.
16. The one or more non-transitory computer-readable media of clauses 14 or 15, wherein the steps further comprise generating a plurality of feature vectors by sampling a plurality of 3D points along rays and projecting each of the plurality of 3D points onto the plurality of orthogonal planes.
17. The one or more non-transitory computer-readable media of any of clauses 14-16, wherein constructing the plurality of deformed 3D Gaussians comprises translating the plurality of 3D Gaussians based on the plurality of motion features.
18. The one or more non-transitory computer-readable media of any of clauses 14-17, wherein training the trained neural network comprises minimizing rendering loss between the rendered 2D image and the second 2D image frame.
19. The one or more non-transitory computer-readable media of any of clauses 14-18, further comprising generating a 4D video using the 4D representation.
20. In some embodiments, a system comprises one or more memories storing instructions, and one or more processors that are coupled to the one or more memories and, when executing the instructions, are configured to perform steps comprising receiving a first 2D image frame, processing the first 2D image frame to generate a plurality of 3D Gaussians, defining a set of motion basis features from the plurality of 3D Gaussians, receiving a second 2D image frame, generating a plurality of augmented images based on the first 2D image frame and the second 2D image frame, processing the first 2D image frame, the second 2D image frame, and the plurality of augmented images to generate a plurality of motion features, constructing a plurality of deformed 3D Gaussians from the motion basis features and the motion features, generating a rendered 2D image from the plurality of deformed 3D Gaussians, generating a 4D representation using a trained neural network.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating four-dimensional (4D) representation, the method comprising:
receiving a first two-dimensional (2D) image frame;
processing the first 2D image frame to generate a plurality of 3D Gaussians;
defining a set of motion basis features from the plurality of 3D Gaussians;
receiving a second 2D image frame;
generating a plurality of augmented images based on the first 2D image frame and the second 2D image frame;
processing the first 2D image frame, the second 2D image frame, and the plurality of augmented images to generate a plurality of motion features;
constructing a plurality of deformed 3D Gaussians from the motion basis features and the motion features;
generating a rendered 2D image from the plurality of deformed 3D Gaussians; and
generating a 4D representation using a trained neural network.

2. The computer-implemented method of claim 1, further comprising transforming the first 2D image frame into a 3D representation by aligning features of the first 2D image frame along a plurality of orthogonal planes.

3. The computer-implemented method of claim 2, further comprising generating a plurality of feature vectors by sampling a plurality of 3D points along rays and projecting each of the plurality of 3D points onto the plurality of orthogonal planes.

4. The computer-implemented method of claim 1, wherein constructing the plurality of deformed 3D Gaussians comprises translating the plurality of 3D Gaussians based on the plurality of motion features.

5. The computer-implemented method of claim 1, wherein the trained neural network is trained by minimizing rendering loss between the rendered 2D image and the second 2D image frame.

6. The computer-implemented method of claim 1, wherein generating the motion features comprises processing the first 2D image frame, the second 2D image frame, and the plurality of augmented images using a vision transformer.

7. The computer-implemented method of claim 1, wherein generating the rendered 2D image comprises performing splatting using the plurality of deformed 3D Gaussians.

8. The computer-implemented method of claim 1, further comprising generating a 4D video using the 4D representation.

9. The computer-implemented method of claim 8, wherein generating the 4D video comprises:
receiving an audio input;
concatenating the audio input and noise removing noise from the concatenated audio input and noise to generate denoised audio features; and
generating the 4D video based on the denoised audio features and the 4D representation.

10. The computer-implemented method of claim 9, wherein generating the 4D video comprises processing the 4D representation with a diffusion model.

11. The computer-implemented method of claim 10, wherein the diffusion model is trained by:
receiving an audio input;
generating noisy features by generating a sequence where, at each step, noise is added to the audio input; and
generating predicted denoised features by generating a sequence, where, at each step noise is iteratively removed.

12. The computer-implemented method of claim 10, wherein the diffusion model is trained by diffusion forcing.

13. The computer-implemented method of claim 10, wherein the noise comprises Gaussian noise.

14. One or more non-transitory computer-readable media storing instructions that, when executed by at least one processor, cause the at least one processor to perform the steps of:
receiving a first 2D image frame;
processing the first 2D image frame to generate a plurality of 3D Gaussians;
defining a set of motion basis features from the plurality of 3D Gaussians;
receiving a second 2D image frame;
generating a plurality of augmented images based on the first 2D image frame and the second 2D image frame;
processing the first 2D image frame, the second 2D image frame, and the plurality of augmented images to generate a plurality of motion features;
constructing a plurality of deformed 3D Gaussians from the motion basis features and the motion features;
generating a rendered 2D image from the plurality of deformed 3D Gaussians;
generating a 4D representation using a trained neural network.

15. The one or more non-transitory computer-readable media of claim 14, wherein the steps further comprise transforming the first 2D image frame into a 3D representation by aligning the features of the first 2D image frame along a plurality of orthogonal planes.

16. The one or more non-transitory computer-readable media of claim 15, wherein the steps further comprise generating a plurality of feature vectors by sampling a plurality of 3D points along rays and projecting each of the plurality of 3D points onto the plurality of orthogonal planes.

17. The one or more non-transitory computer-readable media of claim 14, wherein constructing the plurality of deformed 3D Gaussians comprises translating the plurality of 3D Gaussians based on the plurality of motion features.

18. The one or more non-transitory computer-readable media of claim 14, wherein training the trained neural network comprises minimizing rendering loss between the rendered 2D image and the second 2D image frame.

19. The one or more non-transitory computer-readable media of claim 14, further comprising generating a 4D video using the 4D representation.

20. A system, comprising:
one or more memories storing instructions; and
one or more processors that are coupled to the one or more memories and, when executing the instructions, are configured to perform steps comprising:
receiving a first 2D image frame;
processing the first 2D image frame to generate a plurality of 3D Gaussians;
defining a set of motion basis features from the plurality of 3D Gaussians;
receiving a second 2D image frame;
generating a plurality of augmented images based on the first 2D image frame and the second 2D image frame;
processing the first 2D image frame, the second 2D image frame, and the plurality of augmented images to generate a plurality of motion features;
constructing a plurality of deformed 3D Gaussians from the motion basis features and the motion features;
generating a rendered 2D image from the plurality of deformed 3D Gaussians;
generating a 4D representation using a trained neural network.
